(19) United States
(12) Patent Application Publication
(10) Pub. No.: US 2015/0005062 A1
(43) Pub. Date: Jan. 1, 2015

(54) PROVIDING SITUATIONAL PRIORITY TO PLAYER COMMUNICATIONS IN A MULTI-PLAYER ENVIRONMENT

(71) Applicant: International Business Machines Corporation, Armonk, NY (US)

(72) Inventors: Gary D. Cudak, Creedmoor, NC (US); Lydia M. Do, Raleigh, NC (US); Christopher J. Hardee, Raleigh, NC (US); Adam Roberts, Moncure, NC (US)

(21) Appl. No.: 13/932,325

(22) Filed: Jul. 1, 2013

Related U.S. Application Data
(63) Continuation of application No. 13/930,962, filed on Jun. 28, 2013.

(51) Int. Cl. A63F 13/30

(52) U.S. Cl. CPC A63F 13/12
USPC 463/29

(57) ABSTRACT

A method comprising identifying a communication channel where messages can be sent to a player of a multi-player video game application, monitoring the game application for a game event that applies to the player, generating a priority for a message in response to determining that the game event has occurred, and automatically modifying a message transmitted over the identified communication channel to the player based on the generated priority.

### CROSS-REFERENCE TO RELATED APPLICATIONS

This application is a continuation of U.S. patent application Ser. No. 13/930,962 filed on Jun. 28, 2013, which application is incorporated by reference herein.

### BACKGROUND

1. Field of the Invention

The present invention relates to multi-player video game applications that allow the players to communicate during a game session.

2. Background of the Related Art

A video game involves a person (player) interacting with a user interface, which typically includes a display device and a game controller. A game controller may, for example, include one or more buttons and a joystick. A particular video game application assigns various functions to the buttons and joystick of the game controller to allow the player to provide instructions to the video game application. The video game application then generates visual feedback to the player via the display device.

A player's experience with a video game may be enhanced with audio, such as a soundtrack or sound effects, output through a speaker or headphones. Audio output such as sound effects are typically directly associated with the action occurring in the video game, such as those actions caused by the player's input through the game controller.

While many video games may be played by a single player, other video games allow multiple players to participate in a game simultaneously. Each of the players uses their own user interface to manage their own participation in the game, such as controlling the actions of a character or avatar within the virtual environment defined by the video game application. Some multi-player video games may even be played over a network, such that the location of the players is unlimited and each player has their own independent user interface. Especially in games where the players form teams, the video game may facilitate voice communication between the players.

### BRIEF SUMMARY

One embodiment of the present invention provides a method, comprising identifying a communication channel where messages can be sent to a player of a multi-player video game application, monitoring the game application for a game event that applies to the player, generating a priority for a message in response to determining that the game event has occurred, and automatically modifying a message transmitted over the identified communication channel to the player.

### BRIEF DESCRIPTION OF THE SEVERAL VIEWS OF THE DRAWINGS

FIG. 1 is a diagram of a multi-player video game system.

FIG. 2 is a diagram of a video game server.

FIG. 3 is a diagram of an exemplary computing node (“computer”) that may be utilized in accordance with one or more embodiments of the present invention.

FIG. 4 is a flowchart of a first method of communicating among players in a multi-player video game.

FIG. 5 is a flowchart of a second method of communicating among players in a multi-player video game.

### DETAILED DESCRIPTION

One embodiment of the present invention provides a method, comprising identifying a communication channel where messages can be sent to a player of a multi-player video game application, monitoring the game application for a game event that applies to the player, generating a priority for a message in response to determining that the game event has occurred, and automatically modifying a message transmitted over the identified communication channel to the player.

Optionally, the message to the player may be automatically generated by the game application or received as input from a different player of the game application.

In another embodiment, the game event may be an event that affects the performance of the player. For example, the performance of a player may be the perceived risk to performance of either the sender or receiver. If a first player sending a message (the sender) is on the same team as a second player and perceives that the second player's character or avatar may die, then a message may be sent from the first player and received by the second player to aid with that event or situation. In another specific example, the performance that is at risk may include performance of a single player or multi-player mission objective or achievement.

In further optional embodiments, a game event may be determined to occur in response to: determining that a player's performance will not meet a mission objective or achievement; determining that a player's performance is below a threshold for a mission objective or achievement; determining that a player's involvement is critical to accomplish a mission objective or achievement; or determining that the location of a player, relative to other players or game objects, is important to meeting a mission objective or achievement. In a still further option, the priority of a message is assigned a value proportional to the risk or likelihood of failing or accomplishing a mission objective or achievement.

Automatically modifying a message transmitted over the identified communication channel to the player may include increasing an intensity of the message until the player acknowledges receiving the message. For example, the recipient player might acknowledge receipt of the message by taking a particular action to avoid a threatening game event or taking no particular action specifying ignore. In an alternative example, the player acknowledgement may become moot in response to the mission objective or achievement having already resolved successfully (accomplished) or unsuccessfully (failed).

In a still further embodiment of the method, the message to the player may be directed to be output over a specific user device based upon the game event. More specifically, the message may be directed to the player over a first device in response to a first game event, and directed to the player over a second device in response to a second game event. The first and second devices may include, for example, a first bluetooth speaker, a second speaker, or a mobile device selected on the basis of the particular game event.

The various embodiments of the method may include various types of messages, such as an audio message or a text message. In one option, the message may be an audio message, wherein automatically modifying the message to the player includes increasing the relative volume of audio to the player. In another option, the message is an audio message, wherein automatically modifying the message to the player includes adding a sound effect to the audio message. In yet another option, the message may include an audible alert.

In various embodiments, the game event may be a predetermined game event. Preferably, the game application may include a plurality of predetermined game events. For example, a different sound effect may be associated with each of the plurality of predetermined game events.

According to another embodiment, the step of generating a priority for a message may include determining a priority level from among a plurality of priority levels associated with the game event.

One embodiment of the present invention provides a method, comprising a multi-player video game application receiving input from multiple players over a communications network, wherein the input from each player controls the actions of a corresponding avatar within the video game application and includes an audio message directed to one or more of the multiple players. The method further comprises the multi-player video game application providing output to the multiple players over the communication network, wherein the output to each player includes a video signal responsive to the input from that player and an audio signal including an audio message from at least one of the players. The method monitors a game situation for each of the avatars, and automatically modifies the audio signal to at least one of the players in response to identifying that one of the avatars is in a predetermined game situation.

The input from each player typical includes the use of a game controller having one or more buttons, joysticks or other control means. An input audio message may be obtained by a player speaking into a microphone, which is frequently mounted to a headset which may or may not include a headphone speaker. The game controller, microphone and a speaker are typically in wired or wireless communication with a game console or multipurpose computer that a network interface for communicating over a network, such as the Internet. Audio output to the player may be directed to a speaker associated with the game console or multipurpose computer, a headphone speaker, or both. Optionally, general sound effects may be directed to a speaker associated with the game console or multipurpose computer, while communications between players may be directed to a headphone speaker.

The predetermined game situation may be stored by the video game application and may be one of many predetermined game situations. These predetermined game situations may be established by the game application programmer or designer, or established by one or more players through game preferences or other setup utility or menu system. In a non-limiting example, the predetermined game situation includes a measure of avatar performance during a current game session. More specifically, in a combat type video game, the predetermined situation might be that an avatar's performance has left them without remaining resources, with inadequate means to deal with current conditions, or in an otherwise detrimental situation. Other examples of a predetermined game situation may include a measure of avatar current location within a virtual environment, avatar current proximity to another avatar within the virtual environment, or avatar capabilities relative to another avatar. Still further, the predetermined game situation may be a game event.

Embodiments of the invention include automatically modifying the audio signal to at least one of the players. Such modification may include increasing the relative volume of audio from the player controlling the avatar that is in the predetermined game situation, such as by increasing the player's volume or decreasing or muting the volume of audio from one or more other players. Alternatively, the audio signal may be modified to notify a player that one of the avatars is in the predetermined game situation. Optionally, such a notification may identify the avatar that is in the predetermined game situation to the player being notified. In a further alternative, an audible alert may be provided to one or more of the players. Still further, a sound effect may be added to a voice input of the player associated with the avatar in the predetermined game situation. Optionally, a different sound effect may be associated with each of the plurality of predetermined game situations.

In a further embodiment, the method may determine a priority level among a plurality of priority levels associated with the predetermined game situation. In the combat game example, the predetermined game situation may be an attack on the player and the priority level may be a function of the number of opponent players that are involved in the attack. According to one option, automatically modifying the audio signal to at least one of the players may include modifying the audio signal as a function of the priority level, such as by increasing the volume of a critical message as a function of the priority level, wherein the message is from the player associated with the avatar that is in the predetermined game situation.

In yet another embodiment, the audio signal to at least one of the players is automatically modified to direct the audio message to a player associated with an avatar that has been assigned a role having a predetermined association with the predetermined game situation. For example, when an avatar has become injured in accordance with a predetermined game situation, an audio message from the player associated with the injured avatar may be automatically directed to another player whose avatar has a predetermined association with the predetermined game situation. In this example, an audio message from the player controlling the injured avatar may be automatically directed to another player controlling an avatar that can heal injured avatars.

Another embodiment of the present invention provides a computer program product including computer readable program code embodied on a computer readable storage medium for a multi-player video game application. The computer program product comprises computer readable program code for identifying a communication channel where messages can be sent to a player of a multi-player video game application, computer readable program code for monitoring the game application for a game event that applies to the player, computer readable program code for generating a priority for a message in response to determining that the game event has occurred, and computer readable program code for automatically modifying a message transmitted over the identified communication channel to the player.

Another embodiment of the present invention provides a computer program product including computer readable program code embodied on a computer readable storage medium for a multi-player video game application. The computer program product comprises computer readable program code for receiving input over a communications network from multiple players of the multi-player video game application, wherein the input from each player controls the actions of a corresponding avatar within the video game application and includes an audio message directed to one or more of the multiple players. The computer program product also comprises computer readable program code for providing output to the multiple players over the communication network, wherein the output to each player includes a video signal responsive to the input from that player and an audio signal including an audio message from at least one of the players. The computer program product further comprises computer readable program code for monitoring a game situation for each of the avatars; and computer readable program code for automatically modifying the audio signal to at least one of the players in response to identifying that one of the avatars is in a predetermined game situation.

The foregoing computer program products may further include computer readable program code for implementing or initiating any one or more aspects of the methods described herein. Accordingly, a separate description of the methods will not be duplicated in the context of a computer program product.

### EXAMPLE

In a session of an online multi-player combat type video game, Players 1-4 are playing as a first team against four other players on a second team. All Players 1-4 of the first team are speaking, when avatar 1 (controlled by Player 1) becomes surrounded by avatars controlled by the second team. The game application may determine that avatar 1 is in a predetermined game event or situation, where the game application has been programmed or set up so that the predetermined game event or situation involves multiple avatars of the opposing team being within a certain proximity to a given avatar. As the result of identifying this particular predetermined game event or situation, the game application increases the volume of Player 1's audio signal directed to his teammates, Players 2-4. The volume of audio signals from Players 2-4 may also be automatically decreased, such that any voice message from Player 1 is made more noticeable. If, for example, Player 2 controls an avatar assigned a role for rapid response, then audio directed to Player 2 may be limited to audio from Player 1 until the predetermined game event or situation no longer exists.

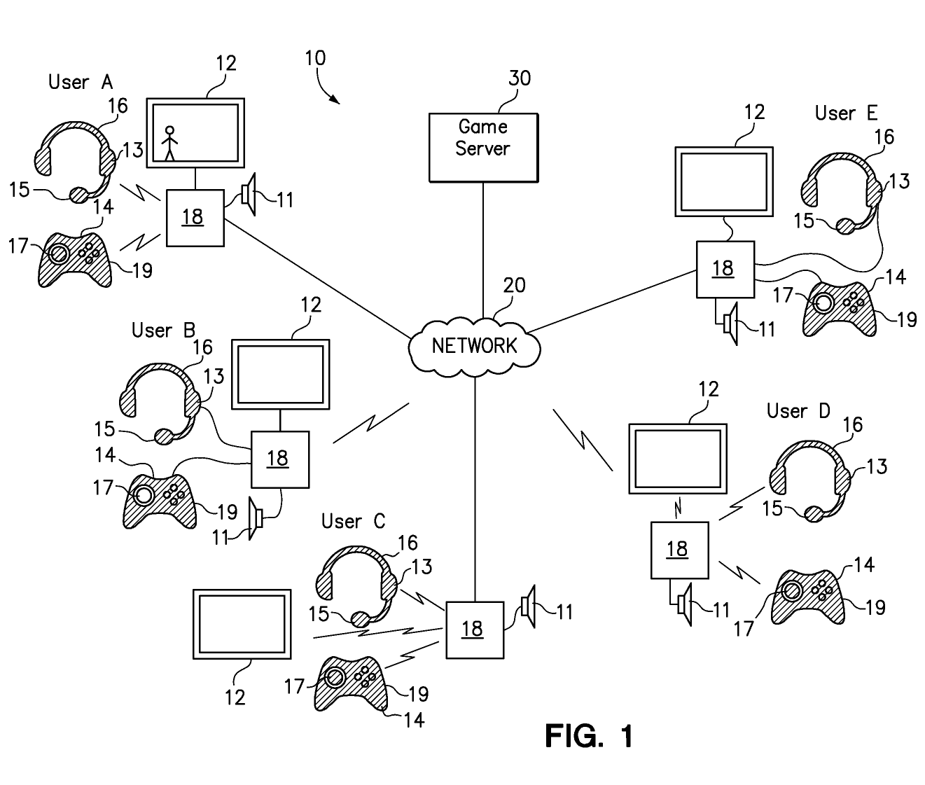

FIG. 1 is a diagram of a multi-player video game system. The multi-player video game system 10 includes a user interface for each of the Players A-E. Each user interface includes a video display device 12, a game controller 14, and a headset 16 that communicate with a local game console or computer 18. Each local device 12, 14, 16 may communicate with the local game console or computer 18 using connections that are wired, wireless, or some combination thereof. The user interface may also include an open speaker 11 and/or a headphone speaker 13 as part of the headset 16 that also includes a microphone 15. In the example shown, the game controller 14 includes a joystick 17 and a group of buttons 19. The user interface may include other devices and other components not shown.

The game consoles or computers 18 provide a network interface that allows communication over the network 20 to a game server 30. The game server 30 is typically separate from each of the game consoles or computers 18, but the game server 30 may also be one or more of the game consoles or computers 18. The game server identifies a communication channel for communicating with each of the game consoles associated with a player (also referred to as a “user”).

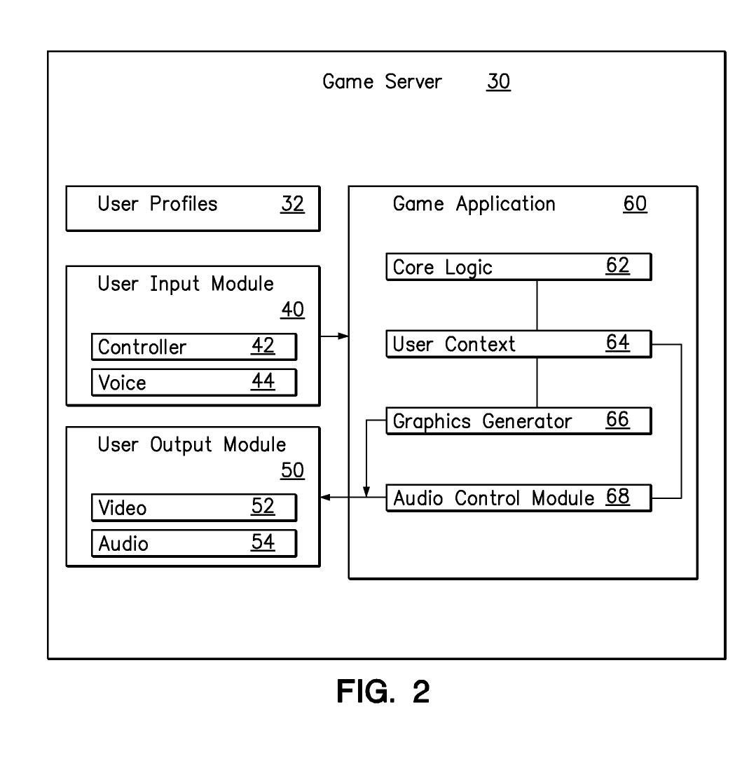

FIG. 2 is a diagram of the video game server 30. The game server 30 includes user profiles 32, a user input module 40, a user output module 50, and a game application 60. The user profiles 32 may store a separate file or record for each authorized user of the game server 30. Each file or record may include long term information about the user's account and history. However, each user profile may also include game-specific information and preferences, such as one or more customized predetermined game events or situations and an indication of how a message should be modified in response to a game event or situation.

The user input module 40 is a network interface that receives input from the individual user interfaces, such as the control signals produced by the game controller 14 (See FIG. 1) and the voice audio signals produced by the microphone 18 (See FIG. 1). Where the network 20 (See FIG. 1) is the Internet, the voice signals may be transmitted using voice over internet protocol (VOIP) such that data packets containing controller signals 42 and voice signals 44 may be very similar. The user input module 40 may be responsible for separating the signals 42, 44 for further processing by the game application 60.

The user output module 50 is a network interface that sends a video signal 52 and an audio signal 54 to the user interface of each player. Specifically, the game application 60 generates a video signal 52 that is transmitted to the display device 12 (See FIG. 1) of the user interface and generates or directs an audio signal 54 to the speaker 11 or headphone speaker 13 (See FIG. 1). While the video signal 52 to a particular user is generated by the game application 60, the content of the video signal 52 transmitted to each user (player) is affected by the signals 42 from the game controller 19 (See FIG. 1) of the same user, and possibly also that of another user. Accordingly, the video signal 52 to each user is typically different, although based upon a common virtual environment. The audio signal 55 may also vary from one user to another, as described herein, in accordance with one or more embodiment of the present invention.

The game application 60 includes the core logic 62 that defines that nature of the video game. During a game session, the user or player may have control over a particular avatar. The collection of game conditions affecting that avatar may be considered to describe the avatar's (user) game context or situation, which is monitored by the user context module 64. The avatar's game context is the basis for the graphics generator 66 to generate a video signal 52 that is output to player associated with that avatar. The avatar's game context may also be used by an audio control module 68 to determine an audio signal 54 to be transmitted to the player associated with that avatar. In accordance with embodiments of the present invention, a message to at least one of the players may be automatically modified in response to the occurrence of a game event, such as one of the avatars being in a predetermined game event or situation. The message may be textual or graphical in nature and sent to a player along with the video signal, and/or the message may be included in the audio signal to a player.

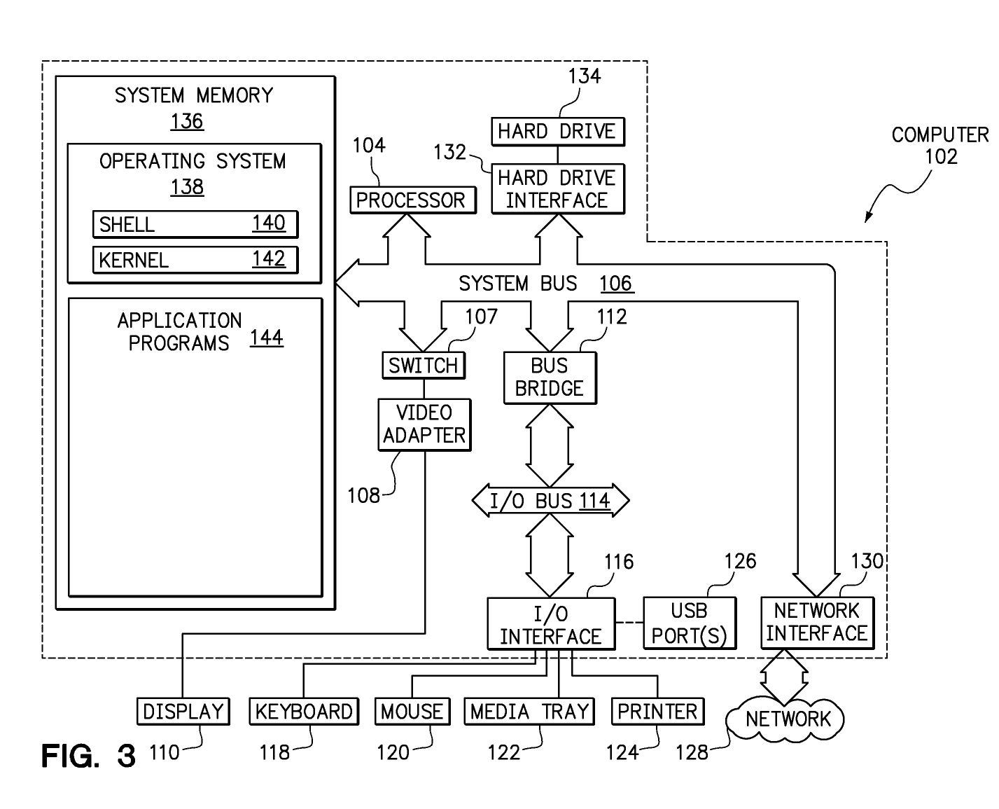

FIG. 3 is a diagram of an exemplary computing node (or simply “computer”) 102 that may be utilized in accordance with one or more embodiments of the present invention. Note that some or all of the exemplary architecture, including both depicted hardware and software, shown for and within computer 102 may be implemented in the as the game console or computer 18 or the game server 30 as shown in FIG. 1.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in a preferred embodiment some or all of these ports are universal serial bus (USB) ports.

As depicted, the computer 102 is able to communicate over a network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

The operating system 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management. Application programs 144 in the system memory of computer 102 may include an electronic transaction program 148 and an authentication module 150 for implementing the methods described herein.

The hardware elements depicted in computer 102 are not intended to be exhaustive, but rather are representative components suitable to perform the processes of the present invention. For instance, computer 102 may include alternate memory storage devices such as magnetic cassettes, digital versatile disks (DVDs), Bernoulli cartridges, and the like. These and other variations are intended to be within the spirit and scope of the present invention.

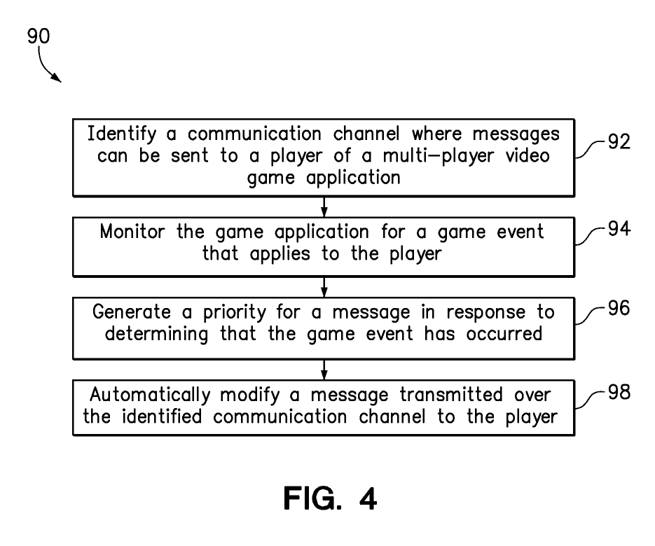

FIG. 4 is a flowchart of a first method 90 of communicating among players in a multi-player video game. In step 92, the method will identify a communication channel where messages can be sent to a player of a multi-player video game application. In step 94, the method monitors the game application for a game event that applies to the player. A priority for a message is generated in response to determining that the game event has occurred in step 96, and the method automatically modifies a message transmitted over the identified communication channel to the player in step 98. The message is modified based on the priority generated in response to the game event.

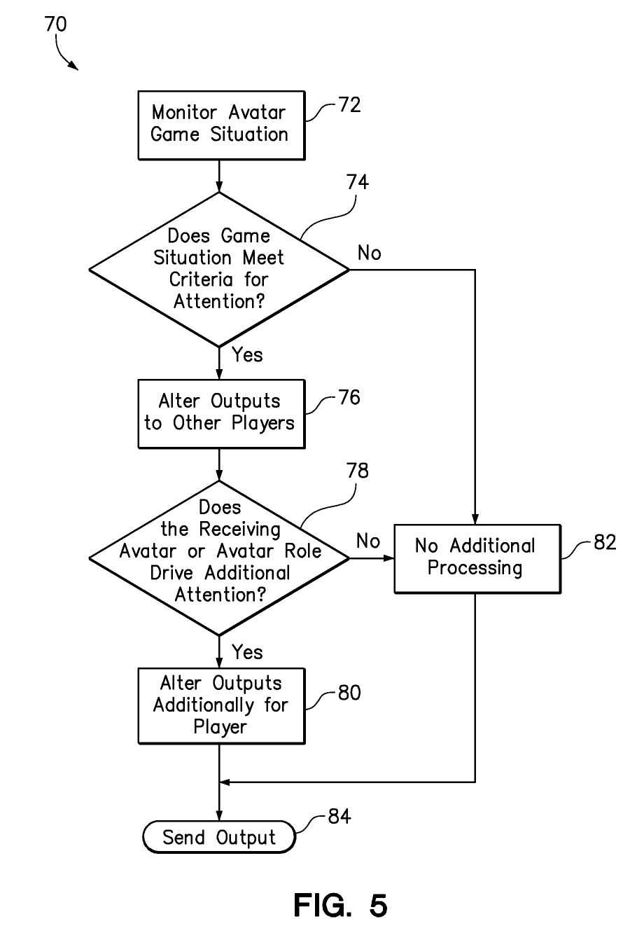

FIG. 5 is a flowchart of a second method 70 of communicating among players in a multi-player video game. In step 72, the avatar game situation is monitored. In step 74, it is determined whether the avatar's game situation meets criteria for attention (i.e., whether the avatar is in a predetermined game situation). If the avatar is in a game situation that meets such criteria, then the audio output to one or more of the other player is altered or modified in step 76. If the avatar is not in a game situation that meets such criteria, then the there is no additional processing (i.e., standard audio, such as equal volumes, is provided) in step 82 prior to sending the audio to the players in step 84.

However, after modifying the audio output to one or more of the other players in step 76, the method determines, in step 78, whether the avatar associated with any of the receiving players (not the player associated with the avatar that is in the predetermined game situation) has a role that drives additional attention. In other words, it is determined whether there is an avatar having a predetermined role within the game that results in additional modification of the audio signal to the player controlling that avatar. For example, if a second avatar has a role of being a first responder, then, in response to a first avatar being in a dangerous predetermined game situation, the audio signal to the player controlling the second avatar is further modified to focus on the audio signal from the player controlling the first avatar. Step 80 alters or modified the audio output to the player identified in step 78 before sending the audio output in step 84. If no such player is identified in step 78, then there is no additional processing of the audio in step 82.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
identifying a communication channel where messages can be sent to a player of a multi-player video game application;
monitoring the game application for a game event that applies to the player;
generating a priority for a message in response to determining that the game event has occurred; and
automatically modifying a message transmitted over the identified communication channel to the player, wherein the message is modified based on the generated priority.

2. The method of claim 1, further comprising:
automatically generating the message to the player.

3. The method of claim 1, wherein the message is received from a different player of the game application.

4. The method of claim 1, wherein the game event is an event that affects the performance of the player.

5. The method of claim 4, where the performance is comprised of a single player or multi-player mission objective or achievement.

6. The method of claim 1, wherein a game event is determined to occur in response to:
determining that a player's performance will not meet a mission objective or achievement;
determining that a player's performance is below a threshold for a mission objective or achievement;
determining that a player's involvement is critical to accomplish a mission objective or achievement; or
determining that the location of a player, relative to other players or game objects, is important to meeting a mission objective or achievement.

7. The method of claim 6, where the priority of a message is assigned a value proportional to the risk or likelihood to meet a mission objective or achievement.

8. The method of claim 1, wherein automatically modifying a message transmitted over the identified communication channel to the player includes increasing an intensity of the message until the player acknowledges receiving the message.

9. The method of claim 1, further comprising:
directing the message to the player to be output over a specific device based upon the game event.

10. The method of claim 9, wherein the message is directed to the player over a first device in response to a first game event, and wherein the message is directed to the player over a second device in response to a second game event.

11. The method of claim 1, wherein the message is selected from an audio message and a text message.

12. The method of claim 1, further comprising:
the multi-player video game application receiving input from multiple players over a communications network, wherein the input from each player controls the actions of a corresponding avatar within the video game application; and
the multi-player video game application providing output to the multiple players over the communication network, wherein the output to each player includes a video signal responsive to the input from that player, and wherein the game event that applies to a player is an event that applies to the corresponding avatar controlled by the player.

13. The method of claim 12, wherein the game event includes a measure of avatar current location within a virtual environment, avatar current proximity to another avatar within the virtual environment, or avatar capabilities relative to another avatar.

14. The method of claim 1, wherein the game event is a predetermined game event.

15. The method of claim 1, wherein the message is an audio message, and wherein automatically modifying the message to the player includes increasing the relative volume of audio to the player.

16. The method of claim 1, wherein the message includes an audible alert.

17. The method of claim 1, wherein the message is an audio message, and wherein automatically modifying the message to the player includes adding a sound effect to the audio message.

18. The method of claim 17, wherein the game application includes a plurality of predetermined game events, and wherein a different sound effect is associated with each of the plurality of predetermined game events.

19. The method of claim 1, wherein generating a priority for a message includes determining a priority level from among a plurality of priority levels associated with the game event.

20. The method of claim 12, wherein the message is transmitted to the player associated with an avatar that has been assigned a role that is associated with the predetermined game situation.
